(19) United States
(12) Patent Application Publication
(10) Pub. No.: US 2013/0019041 A1
(43) Pub. Date: Jan. 17, 2013

(54) BIT SLICE ROUND ROBIN ARBITER

(71) Applicants: Laurence E. Bays, Allentown, PA (US); Ballori Banerjee, Bangalore (IN); James F. Vomero, Orefield, PA (US)

(72) Inventors: Laurence E. Bays, Allentown, PA (US); Ballori Banerjee, Bangalore (IN); James F. Vomero, Orefield, PA (US)

(73) Assignee: LSI Corporation, Milpitas, CA (US)

(21) Appl. No.: 13/180,660

(22) Filed: Jul. 12, 2011

(51) Int. Cl. G06F 13/14

(52) U.S. Cl. 710/244

(57) ABSTRACT

The present disclosure describes systems and methods for arbitrating between a plurality of devices competing for a system resource. Operations of the system and method may include, but are not limited to: initializing two or more previous grant request states; generating an access grant signal according to the two or more requests for access to the shared resource, two or more token states and the two or more previous grant request states; and generating an access grant signal according to the two or more requests for access to the shared resource, two or more token states and the two or more previous grant request states.

### BACKGROUND

When there are a large number of requestors for a shared resource, an arbiter is required to manage how the requests would be serviced. A round-robin scheme tries to give a fair share of bandwidth to each of the requestors.

For N number of incoming requesters for a shared resource, a round-robin arbiter works to provide fair bandwidth allocation to each requestor, where in every clock cycle at most one request gets the grant and is serviced. If Requestᵢ is the request with grant in a current cycle, in the next cycle Requestᵢ₊₁ should get the grant, if active, followed by Requestᵢ₊₂, and so on till Request_{N-1}. The grant moves in a cycle through all the incoming requests. If multiple requests are active in any cycle the one with the maximum priority in the circular round-robin arbitration scheme is serviced.

A few known ways in which to design a round-robin arbiter are: 1) in the simple way with a case statement and many if-else, if-else, if for each case. This results in a large gate count and area. This is typically implemented with a priority multiplexer to prioritize between existing incoming requests in every clock cycle; 2) with a barrel shifter, whose output places the previous request grant position always at the end, and a priority encoder of the barrel shifter output to identify the first request position from the start for next grant. The size of this will be larger as the barrel shifter size grows with the square of the number of inputs; 3) utilizing a mask to select only the requests after the previous request granted and priority encoding to identify the first request position to be granted next. This implementation also requires priority encoding of twice the number of actual request inputs to implement wrapping.

### SUMMARY

The present disclosure describes systems and methods for arbitrating between a plurality of devices competing for a system resource. Operations of the system and method may include, but are not limited to: initializing two or more previous grant request states; generating an access grant signal according to the two or more requests for access to the shared resource, two or more token states and the two or more previous grant request states; and generating an access grant signal according to the two or more requests for access to the shared resource, two or more token states and the two or more previous grant request states.

### BRIEF DESCRIPTION OF THE DRAWINGS

The numerous advantages of the disclosure may be better understood by those skilled in the art by reference to the accompanying figures in which:

FIG. 1 illustrates an arbitration system;

FIG. 2 illustrates an arbitration system;

FIG. 3 shows a bit slice cell of an arbitration system;

FIG. 4 shows an operational flow diagram associated with an arbitration system; and

FIG. 5 shows a timing diagram associated with an arbitration system.

### DETAILED DESCRIPTION

The present invention is directed to a round-robin arbiter system employing one or more bit slices. Such a system has the advantage that the arbiter's size requires only a few gates per request input and its total size can be linear with the number of request inputs.

Reference will now be made in detail to the subject matter disclosed, which is illustrated in the accompanying drawings.

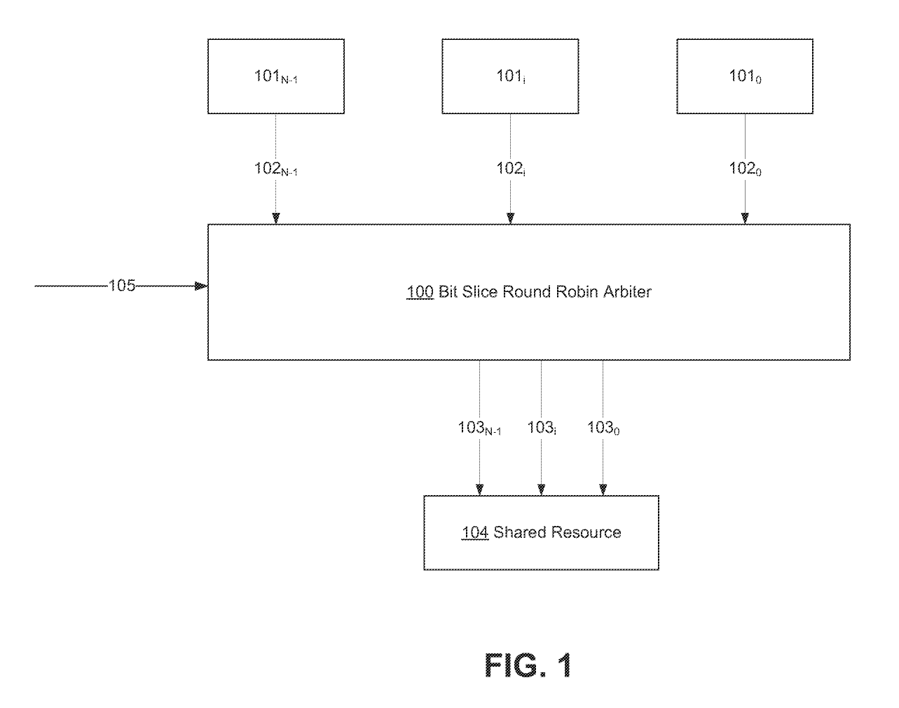

FIG. 1 shows a system 100 for arbitrating among a plurality of N requesting devices 101 (e.g. requesting devices 101_{N-1}, 101ᵢ and 101₀ requesting access to a shared resource 104. Each requesting device 101 may submit a request signal 102 to system 100. The system 100 may grant resource access to at most a single requesting device of the N resource requesting devices 101. Furthermore, the system 100 may have at most one active service grant signal 103 pertaining to a single requesting device 101 at a given time.

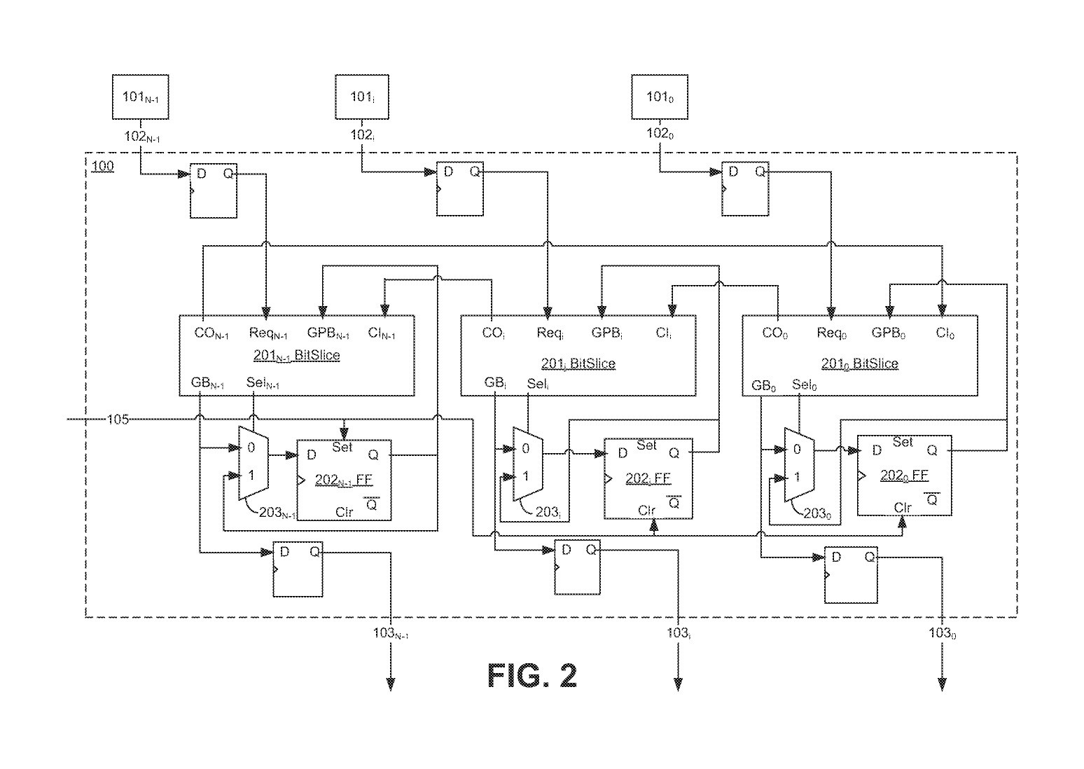

FIG. 2 depicts an exemplary embodiment of system 100. System 100 may include N Bit Slices 201 (e.g. BitSlice 201_{N-1}, 201ᵢ, 201₀). Each BitSlice 201 may include a Carry-Out Bit (CO), a Request bit (Req), a Grant (Previous) Bit (GPB), a Carry-In Bit (CI), and a Grant (Current) Bit (GB). An arbitrary resource requesting device 101ᵢ of the N requesting devices 101 may have its request signal 102ᵢ coupled to Reqᵢ of BitSlice 201ᵢ. An arbitrary BitSlice 201ᵢ may have its COᵢ coupled with the CIᵢ₊₁ of a second BitSlice 201ᵢ₊₁ so that the two bits have the same value. The CO_{N-1} of BitSlice 201_{N-1} may be coupled with CI₀ of BitSlice 201₀. All N BitSlices 201 may have their GBᵢ coupled to the input of a D flip flop 202. For example, GBᵢ may be coupled to the input of D flip flop 202ᵢ. Each D flip flop 202 may have its output Q coupled to the GPBᵢ of its corresponding BitSlice 201 so that the two bits have the same value. An asserted GBᵢ may correspond with requesting device 101ᵢ being granted access to the resource.

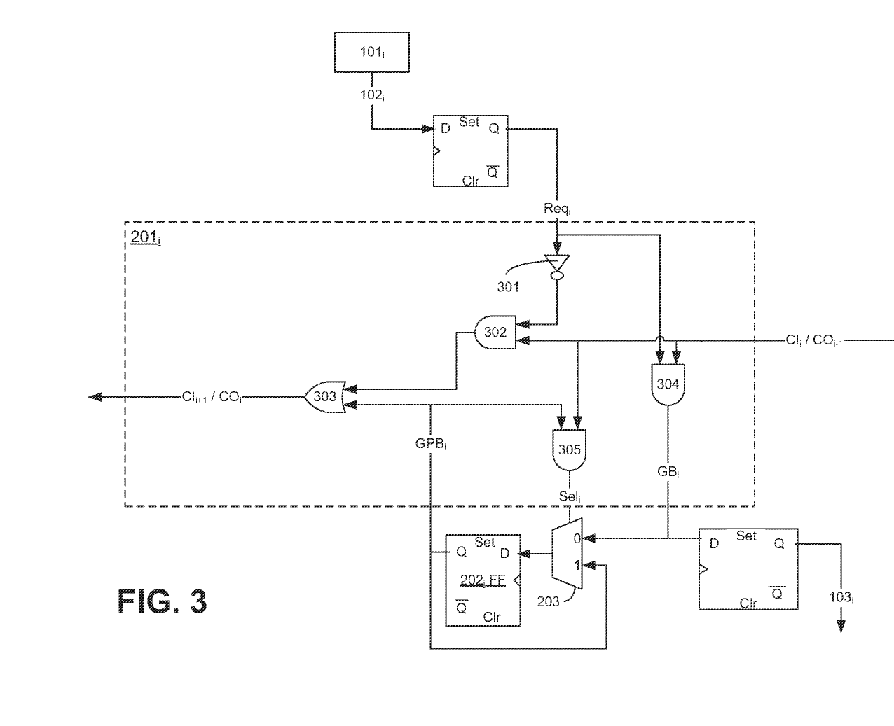

FIG. 3 exhibits a more detailed view of a BitSlice 201ᵢ and a corresponding D flip-flop 202ᵢ. A request bit Reqᵢ from a requesting device 101ᵢ may be coupled to the input of an inverter 301. An AND gate 302 may have CIᵢ (received as COᵢ₋₁ of BitSlice 201ᵢ₋₁) and the output of inverter 301 as inputs. An OR gate 303 may have the output of AND gate 302 and GPBᵢ as inputs. An AND gate 304 may have Reqᵢ and CIᵢ as inputs. Flip Flop 202ᵢ may have the output of AND gate 304 (i.e. GBᵢ) as an input.

Further, it may be the case that, when no request for access for a given requesting device 101 is pending (i.e. Reqᵢ and GBᵢ are not asserted), the value of GPBᵢ is retained from the previous clock cycle. For example, as shown in FIG. 3, when GPBᵢ is asserted and CIᵢ is asserted (as resulting from the states of Reqᵢ and GBᵢ), the output of AND gate 305 may be provided as a control signal Selᵢ to a MUX 203 thereby selecting between a presently computed value for GBᵢ and the value of GPBᵢ for storage in FFᵢ 202.

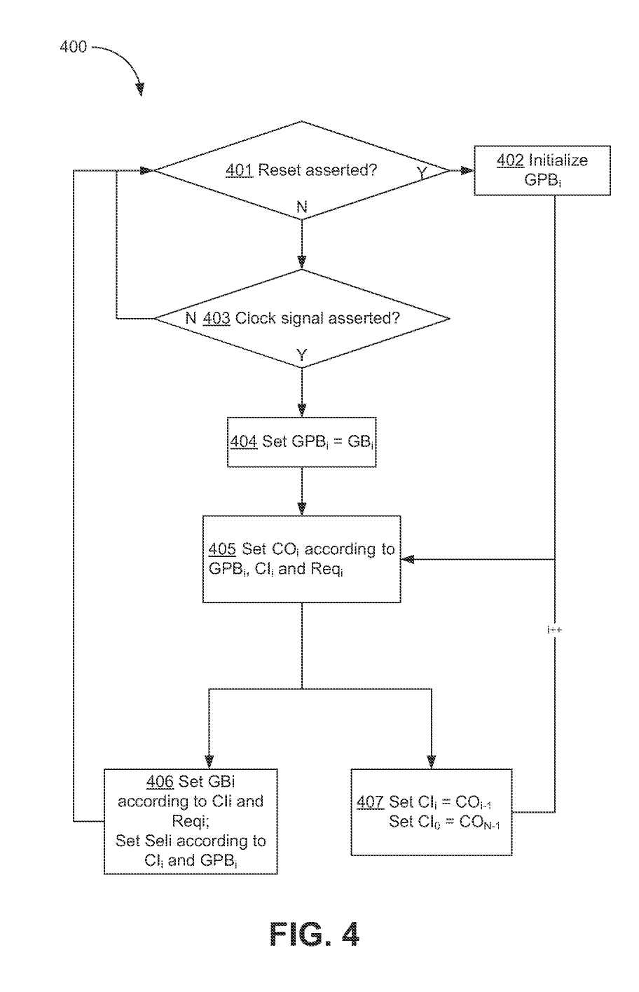

FIG. 4 is a flow chart that illustrates a method 400 of arbitrating among a plurality of requesting devices 101 requesting access to a shared resource 104. The method 400 may be continuously active. Operation 401 illustrates determining whether a reset signal 105 is asserted. If reset signal 105 is asserted, GPBᵢ for each BitSlice 201, may be initialized to a desired value as shown at operation 402. For example, as shown in FIG. 2, GPB_{N-1} may be asserted while GPB_{N-2} to GPB₀ may be unasserted.

If reset signal 105 is not asserted, a determination may be made as to whether the rising edge clock signal is asserted as shown at operation 403. If the clock signal is not asserted, operation 401 may be repeated. If the clock signal is asserted, FF 202ᵢ may be configured such that GPBᵢ is set to the current value of GBᵢ. Next, COᵢ may be recalculated based on the new value of GPBᵢ and current values of CIᵢ and Reqᵢ as shown at operation 405. Specifically, COᵢ may be set according to the following Boolean equation:

COᵢ=GPBᵢ OR (CIᵢ and [symbol] Reqᵢ)

Further, CIᵢ for each of BitSlice 201_{N-1} to BitSlice 201₀ may be set according to:

CIᵢ=COᵢ₋₁

CI₀=CO_{N-1}

as shown at operation 407.

Still further, at operation 406, GBᵢ may be set according to the following Boolean equation:

GBᵢ=Reqᵢ AND CIᵢ.

As shown in FIG. 4, operations 405 and 407 may be carried out for each BitSlice 201ᵢ for i=0 to N−1, there by propagating the respective CI and CO signals across all BitSlices 201. For example, the propagation across the BitSlices 201 may commence with a BitSlice 201ᵢ that has an asserted GPB signal and progress from BitSlice 201ᵢ to BitSlice 201_{N-1}, wrap around to BitSlice 201₀ and conclude with BitSlice 201ᵢ₋₁. Upon complete propagation of the respective CI and CO across all BitSlices 201, at most, a single BitSlice 201 will have an asserted GB, (e.g. a state indicative of possession of a shared resource access token) while the remaining BitSlices 201 will have an unasserted GBᵢ (e.g. a state indicative of lack of possession of a shared resource access token).

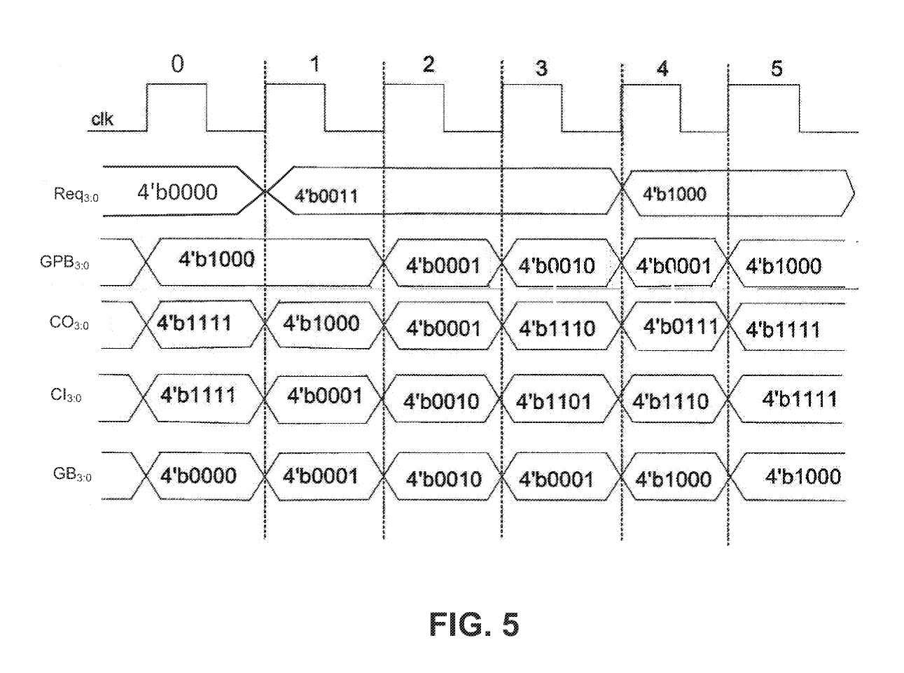

FIG. 5 shows a timing diagram representing an example of how the various bits of a BitSlice 201ᵢ may vary according to method 400. For example, system 100 may arbitrate between 4 competing resource requesting devices 101. At clock pulse 0, Grant Previous Bits may be reset as follows: GPB₃=1, GPB₂=0, GPB₁=0, GPB₀=0 (i.e. GPB_{3:0}=1000) as shown at operation 402. At clock pulse 1, Carry Out Bits may be calculated as CO_{3:0}=1000 as shown at operation 405. In this example, since the value of CO_{3:0} changed as a result of operation 405, those changes are propagated to the values of CI resulting in CI_{3:0}=0001 at operation 407. In this example, operation 406 may be executed resulting in GB_{3:0}=0001 thereby allowing for servicing of an I/O request by a requesting device 101₀.

At clock pulse 2, GPB₃₀ may be set to GB₃₀ of clock pulse 1 at operation 404. Operation 405 may thus result in CO_{3:0}=0001. In this example, since the value of CO_{3:0} changed as a result of operation 405, at operation 407 those changes are propagated to the values of CI_{3:0}, resulting in CI_{3:0}=0010. In this example, operation 406 may be executed, resulting in GB_{3:0}=0010 thereby allowing for servicing of an I/O request by a requesting device 101₁. Bit values change accordingly at clock pulses 3, 4, and 5.

Further, the clock signal to the flip-flops 202 may be gated/qualified with an acknowledge signal (not shown) from a shared resource 104. Specifically, in the absence of the acknowledge signal thereby indicating that shared resource 104 cannot accept a new request until it has finished processing the current request, the clock signal coupled to the flip-flops 202 would not be asserted.

It is believed that the present invention and many of its attendant advantages will be understood by the foregoing description. It may be also believed that it will be apparent that various changes may be made in the form, construction and arrangement of the components thereof without departing from the scope and spirit of the invention or without sacrificing all of its material advantages. The form herein before described being merely an explanatory embodiment thereof. It may be the intention of the following claims to encompass and include such changes.

The foregoing detailed description may include set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

In addition, those skilled in the art will appreciate that the mechanisms of the subject matter described herein may be capable of being distributed as a program product in a variety of forms, and that an illustrative embodiment of the subject matter described herein applies regardless of the particular type of signal bearing medium used to actually carry out the distribution. Examples of a signal bearing medium include, but may be not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Those having skill in the art will recognize that the state of the art may include progressed to the point where there may be little distinction left between hardware, software, and/or firmware implementations of aspects of systems; the use of hardware, software, and/or firmware may be generally (but not always, in that in certain contexts the choice between hardware and software may become significant) a design choice representing cost vs. efficiency tradeoffs. Those having skill in the art will appreciate that there may be various vehicles by which processes and/or systems and/or other technologies described herein may be effected (e.g., hardware, software, and/or firmware), and that the preferred vehicle will vary with the context in which the processes and/or systems and/or other technologies may be deployed. For example, if an implementer determines that speed and accuracy may be paramount, the implementer may opt for a mainly hardware and/or firmware vehicle; alternatively, if flexibility may be paramount, the implementer may opt for a mainly software implementation; or, yet again alternatively, the implementer may opt for some combination of hardware, software, and/or firmware. Hence, there may be several possible vehicles by which the processes and/or devices and/or other technologies described herein may be effected, none of which may be inherently superior to the other in that any vehicle to be utilized may be a choice dependent upon the context in which the vehicle will be deployed and the specific concerns (e.g., speed, flexibility, or predictability) of the implementer, any of which may vary. Those skilled in the art will recognize that optical aspects of implementations will typically employ optically oriented hardware, software, and or firmware.

1. A method of arbitrating among two or more devices requesting access to a shared resource, comprising:
initializing two or more previous grant request states;
receiving two or more requests for access to a shared resource; and
generating an access grant signal according to the two or more requests for access to the shared resource, two or more token states and the two or more previous grant request states.

2. The method of claim 1, wherein the initializing two or more previous grant request states comprises:
setting a previous grant bit of a first bit slice to a first logical value and setting a previous grant bit of one or more second bit slices to a second logical value.

3. The method of claim 1,
wherein the access grant signal is generated by at least one bit slice comprising:
a request bit operably coupled to an access requesting device;
a carry-in bit operably coupled to a second bit slice;
a previous grant bit;
a carry-out bit; and
a current grant bit operably coupled to the shared resource.

4. The method of claim 3 wherein the generating an access grant signal according to the two or more requests for access to the shared resource, two or more token states and the two or more previous grant request states comprises:
setting a carry out bit of a bit slice to a first value if:
the previous grant bit is asserted; or
the carry-in bit is asserted and the request bit is not asserted.

5. The method of claim 4 wherein the generating an access grant signal according to the two or more requests for access to the shared resource, two or more token states and the two or more previous grant request states comprises:
asserting the current grant bit if:
the request bit is asserted; and
the carry-in bit is asserted.

6. The method of claim 3, further comprising:
setting the previous grant bit equal to the current grant bit.

7. An arbiter cell comprising:
an inverter configured to receive a request signal from a device requesting access to a shared resource;
a first AND-gate configured to receive a carry-in signal from a second arbiter cell and an output of said inverter;
a second AND-gate configured to receive the request signal and the carry-in signal;
a D flip-flop configured to receive an output of said second AND-gate; and
an OR-gate configured to receive an output of the D flip flop and the output of said first AND.

8. A system that arbitrates two or more requests sent from two or more requesters, comprising:
means for initializing two or more previous grant request states;
means for generating an access grant signal according to the two or more requests for access to the shared resource, two or more token states and the two or more previous grant request states; and
means for generating an access grant signal according to the two or more requests for access to the shared resource, two or more token states and the two or more previous grant request states.

9. The system of claim 8, wherein the initializing two or more previous grant request states comprises:
setting a previous grant bit of a first bit slice to a first logical value and setting a previous grant bit of one or more second bit slices to a second logical value.

10. The system of claim 8,
wherein the access grant signal is generated by at least one bit slice comprising:
a request bit operably coupled to an access requesting device;
a carry-in bit operably coupled to a second bit slice;
a previous grant bit;
a carry-out bit; and
a current grant bit operably coupled to the shared resource.

11. The system of claim 10, wherein the generating an access grant signal according to the two or more requests for access to the shared resource, two or more token states and the two or more previous grant request states comprises:
setting a carry out bit of a bit slice to a first value if:
the previous grant bit is asserted; or
the carry-in bit is asserted and the request bit is not asserted.

12. The system of claim 11, wherein the generating an access grant signal according to the two or more requests for access to the shared resource, two or more token states and the two or more previous grant request states comprises:
asserting the current grant bit if:
the request bit is asserted; and
the carry-in bit is asserted.

13. The system of claim 10, further comprising:
setting the previous grant bit equal to the current grant bit.
